(19) United States
(12) Patent Application Publication
(10) Pub. No.: US 2026/0006291 A1
(43) Pub. Date: Jan. 1, 2026

(54) INFORMATION PROCESSING APPARATUS, SYSTEM FOR INFORMATION PROCESSING APPARATUS, AND CONTROL METHOD FOR INFORMATION PROCESSING APPARATUS

(71) Applicant: CANON KABUSHIKI KAISHA, Tokyo (JP)

(72) Inventor: SEIJI OGAWA, Tokyo (JP)

(21) Appl. No.: 19/320,640

(22) Filed: Sep. 5, 2025

Related U.S. Application Data
(63) Continuation of application No. PCT/JP2024/005421, filed on Feb. 16, 2024.

(30) Foreign Application Priority Data
Mar. 9, 2023 (JP) 2023-036745

(51) Int. Cl. H04N 21/442; G06F 3/01; G09G 5/377; G09G 5/38

(52) U.S. Cl. CPC H04N 21/44218; G06F 3/013; G09G 5/377; G09G 5/38; G09G 2340/0464

(57) ABSTRACT

An information processing apparatus includes a display control unit configured to display a video on a display portion, a gaze acquisition unit configured to acquire gaze information of a user, a recording unit configured to record the gaze information when display of the video is stopped, and a playback control unit configured to stop the video when the display of the video is stopped and resume the video based on the gaze information recorded in the recording unit when display of the video is resumed.

### CROSS-REFERENCE TO RELATED APPLICATIONS

This application is a Continuation of International Patent Application No. PCT/JP2024/005421, filed Feb. 16, 2024, which claims the benefit of Japanese Patent Application No. 2023-036745, filed Mar. 9, 2023, both of which are hereby incorporated by reference herein in their entirety.

### BACKGROUND

### Field of the Technology

The present disclosure relates to an information processing apparatus that detects gaze.

### Description of the Related Art

In recent years, a virtual reality (VR) technology that allows users to experience space different from real space by using head mounted displays (HMDs) is known. With an HMD, VR videos of which the view direction is freely changeable can be viewed, and, when such VR videos are viewed, a partial range of the video is cropped according to the view direction and displayed on the display portion of the HMD. Many HMDs are equipped with a function (pass-through) that allows users to check the scene of real space in real time through a live view while wearing the HMDs. There is known a technology to, when a user uses the above-described pass-through function while playing a video, automatically pause the video and, after the pass-through ends, change viewpoint information according to the movement of the HMD and automatically play the video from where it is left off at a view point according to the position of the HMD. Japanese Patent Laid-Open No. 2021-144599 can be cited as a related art that relates to such VR videos.

### SUMMARY

One aspect of the present disclosure is an information processing apparatus. The information processing apparatus includes a display control unit configured to display a video on a display portion, a gaze acquisition unit configured to acquire gaze information of a user, a recording unit configured to record the gaze information when display of the video is stopped, and a playback control unit configured to stop the video when display of the video is stopped and resume the video based on the gaze information recorded in the recording unit when display of the video is resumed.

According to the present disclosure, it is possible to provide an information processing apparatus with which a video can be viewed while missing out on changes in view point can be prevented during a period from when display of the video is stopped to when display of the video is resumed.

Features of the present disclosure will become apparent from the following description of embodiments with reference to the attached drawings.

### BRIEF DESCRIPTION OF THE DRAWINGS

FIG. 1A is an example of the appearance view of a smartphone 100 that is a type of information processing apparatus in a first embodiment of the present disclosure.

FIG. 1B is an example of the appearance view of the other side of the smartphone 100 in the first embodiment of the present disclosure.

FIG. 1C is an example of the configuration of the smartphone 100 in the first embodiment of the present disclosure.

FIG. 1D is the appearance view of VR goggles (head mounted adapter) 200 that can mount the smartphone 100 in the first embodiment of the present disclosure.

FIG. 2A is the appearance view of hand-held controllers of a display apparatus in the first embodiment of the present disclosure.

FIG. 2B is the appearance view and worn example of a ring controller of a display apparatus in the first embodiment of the present disclosure.

FIG. 3 is a flowchart that shows a video viewing mode process of the display apparatus in the first embodiment of the present disclosure.

FIG. 4A is a screen example in which a VR video is played in a video viewing mode of the display apparatus in the first embodiment of the present disclosure.

FIG. 4B is a screen example after a pause operation has been performed in the video viewing mode of the display apparatus in the first embodiment of the present disclosure.

FIG. 4C is a screen example after a play operation has been performed in the video viewing mode of the display apparatus in the first embodiment of the present disclosure.

FIG. 4D is a screen example after switching to pass-through display in the video viewing mode of the display apparatus in the first embodiment of the present disclosure.

FIG. 4E is a screen example of a state of viewing straight behind (180° opposite direction) from the state of FIG. 4D in the video viewing mode of the display apparatus in the first embodiment of the present disclosure.

FIG. 4F is a screen example after ending the pass-through in the video viewing mode of the display apparatus in the first embodiment of the present disclosure.

FIG. 4G is a screen example where the view direction has been rotated 90° to the left from the scene of FIG. 4E in the video viewing mode of the display apparatus in the first embodiment of the present disclosure.

FIG. 4H is a screen example that shows a state where the view direction has been further changed from FIG. 4G in the video viewing mode of the display apparatus in the first embodiment of the present disclosure and is oriented in the same direction as those in FIGS. 4A to 4C.

FIG. 4I is a screen example of a state where the video is resumed in the video viewing mode of the display apparatus in the first embodiment of the present disclosure.

FIG. 4J is a screen example when a buffer region is provided in the video viewing mode of the display apparatus in the first embodiment of the present disclosure.

FIG. 5A is a screen example when a predetermined object 501 is stored in the video viewing mode of the display apparatus in the first embodiment of the present disclosure.

FIG. 5B is a screen example that shows an arrow 502 indicating the position of the stored coordinate or region in the video viewing mode of the display apparatus in the first embodiment of the present disclosure.

FIG. 5C is a screen example that shows a mark 503 on a view direction indicator 402 in the video viewing mode of the display apparatus in the first embodiment of the present disclosure.

FIG. 5D is a screen example in which an indicator 504 indicating a direction is added onto the screen in the video viewing mode of the display apparatus in the first embodiment of the present disclosure.

FIG. 5E is a screen example that changes display to show a relative position in the video viewing mode of the display apparatus in the first embodiment of the present disclosure.

### DESCRIPTION OF THE EMBODIMENTS

In the above-described existing technology, when the view point position of the HMD changes during the pass-through, the range that was being viewed before the start of the pass-through and the range of the video that is automatically played at the end of the pass-through can be different from each other, so there is an issue that users may miss the range they want to view. Therefore, the present disclosure aims to provide an information processing apparatus that prevents missing a VR video before and after the pass-through while maintaining the sense of immersion. The pass-through function has been described as an example in which the view direction is likely to change when the view of a VR video is interrupted, a function other than the VR video is used, and then the view of the VR video is resumed. However, not limited to this case, such an issue can arise if the view direction changes before and after the interruption of view of a VR video even when a function other than the VR video is being used.

Hereinafter, preferred embodiments of the present disclosure will be described in detail with reference to the attached drawings.

The embodiments described below are examples of means for implementing the present disclosure, and may be modified or changed as needed depending on the configuration of an apparatus to which the present disclosure is applied and various conditions. The embodiments may be combined as needed. Like reference signs denote the identical or similar components in the attached drawings, and the repeated description is omitted.

### First Embodiment

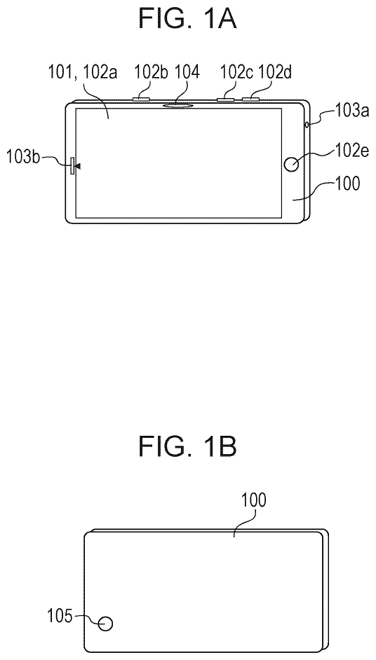

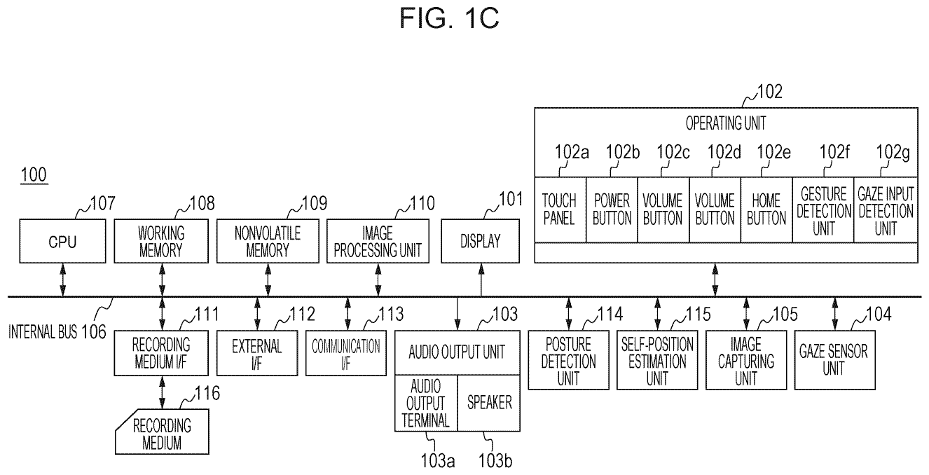

FIG. 1A shows an example of the appearance view of a smartphone 100 that is a type of information processing apparatus.

Here, a smartphone that is an example of the information processing apparatus, and VR goggles (head mounted adapter) that allow VR videos (VR contents) to be viewed when the smartphone is mounted will be described. The information processing apparatus may be an HMD used solely (standalone HMD), or an HMD and the information processing apparatus may be connected to share processes. The smartphone and the VR goggles may also have an integrated housing. The smartphone may be used without being mounted to the VR goggles (head mounted adapter). The information processing apparatus may be a tablet terminal or a PC.

A display 101 is a display portion that displays images and various pieces of information. The display 101 is configured integrally with a touch panel 102a as will be described later, and is capable of detecting touch operations on the display surface of the display 101. The smartphone 100 is capable of displaying VR videos (VR contents) in VR on the display 101. An operating unit 102 includes the touch panel 102a, a power button 102b, a volume button 102c, a volume button 102d, and a home button 102e, as shown in the drawing. The operating unit 102 is an input device for accepting user operations and includes a character information input device such as a keyboard, a pointing device such as a mouse and a touch panel, a button, a dial, a joystick, a touch sensor, and a touch pad. The touch panel 102a is configured in a flat shape and laid on the display 101, and is an input device configured to output coordinate information corresponding to the position touched. The power button 102b is a power button that accepts operations to switch the power of the smartphone 100 between an on state and an off state. The volume button 102c and the volume button 102d are operating portions for increasing or decreasing the volume of sound output from an audio output unit 103. The home button 102e is an operating portion for displaying a home screen on the display 101. The audio output unit 103 includes an audio output terminal 103a and a speaker 103b. The audio output terminal 103a is an earphone jack that is a jack for inserting a terminal of earphones, external speakers, and the like (an earphone plug or a phone plug) to output sound. The speaker 103b is a built-in speaker that produces sound. The audio output unit 103 may include only one of the two. The earphone jack of the audio output terminal 103a may be any size, may be any of a two-pole type, a three-pole type, or a four-pole type, and may also employ a Lightning terminal. A gaze sensor unit 104 is a sensor that detects the gaze of a user of the smartphone 100.

FIG. 1B shows an example of the appearance view of the other side of the smartphone 100. An image capturing unit 105 is a camera capable of capturing pictures. The image capturing unit 105 includes, for example, an optical system that controls an optical lens unit, aperture, zoom, and focus, an image pickup element used to convert light (picture) introduced through the optical lens unit into an electrical picture signal. A complementary metal oxide semiconductor (CMOS) or a charge coupled device (CCD) is commonly used as the image pickup element. The image capturing unit 105 converts the subject light focused by lenses included in the image capturing unit 105 into an electrical signal by the image pickup element, performs noise reduction processing or the like, and outputs the digital data as image data, under the control of the control unit 107.

FIG. 1C shows an example of the configuration of the smartphone 100. The smartphone 100 can be configured by using a display apparatus, such as a smartphone. The control unit 107, a working memory 108, a nonvolatile memory 109, an image processing unit 110, the display 101, the operating unit 102, a recording medium I/F 111, an external I/F 112, and a communication I/F 113 are connected to an internal bus 106. The audio output unit 103, the gaze sensor unit 104, a posture detection unit 114, and a self-position estimation unit 115 are also connected to the internal bus 106. Components connected to the internal bus 106 are designed to exchange data with each other via the internal bus 106.

The control unit 107 is a CPU that controls the entire smartphone 100 and is made up of at least one processor or circuit.

The working memory 108 is made up of, for example, an RAM (such as a volatile memory using semiconductor elements). The control unit 107 controls the units of the smartphone 100 by using the working memory 108 as a work memory in accordance with a program stored in, for example, the nonvolatile memory 109.

The nonvolatile memory 109 is an electrically erasable and recordable nonvolatile memory that stores image data, audio data, other data, various programs for the control unit 107 to operate, and the like. The nonvolatile memory 109 is made up of, for example, a flash memory, an ROM, or the like.

The image processing unit 110 performs various image processing on images stored in the nonvolatile memory 109 and the recording medium 116, picture signals acquired via the external I/F 112, images acquired via the communication I/F 113, and the like, based on the control of the control unit 107. The image processing performed by the image processing unit 110 includes an analog-to-digital conversion process, a digital-to-analog conversion process, and an encoding process, compression process, decoding process, magnification/reduction process (resize process), noise reduction process, color conversion process, and the like, of image data. The image processing unit 110 also performs various types of image processing, such as panorama unfolding, a mapping process, transformation, and the like, of VR videos, which omnidirectional images or not omnidirectional but wide-range images having a wide range of data. The image processing unit 110 may be made up of dedicated circuit blocks for performing specific image processing. Depending on the type of image processing, the control unit 107 can perform image processing in accordance with a program without using the image processing unit 110.

The display 101 displays images, GUI screens that make up graphical user interfaces (GUIs), and the like, based on the control of the control unit 107. The control unit 107 generates display control signals in accordance with a program and controls the units of the smartphone 100 to generate picture signals for display on the display 101 and output the picture signals to the display 101. The display 101 displays pictures based on the output picture signals. The components of the smartphone 100 itself may include up to an interface for outputting picture signals for display on the display 101, and the display 101 may be made up of an external monitor (such as a television).

The recording medium I/F 111 is capable of loading the recording medium 116, such as memory cards, CDs, and DVDs, and reads data from the loaded recording medium 116 and writes data to the recording medium 116 based on the control of the control unit 107.

The external I/F 112 is an interface that connects to external devices via wired cables or wirelessly to input and output picture signals and audio signals.

The communication I/F 113 is an interface that communicates with external devices, the Internet, and the like, to transmit and receive various data, such as files and commands. The communication I/F 113 is also capable of communicating with wirelessly connected controllers 300, 310, and the like (described later). The communication I/F 113 performs communication via wired methods such as USB cables or wireless methods such as Bluetooth and Wireless Fidelity (Wi-Fi).

The audio output unit 103 outputs sound of video and music data, operating sounds, ringtones, and various notification sounds. The audio output unit 103 includes the audio output terminal 103a for connecting earphones and the speaker 103b, and may also output sound via wireless communication or the like.

The posture detection unit 114 detects the posture of the smartphone 100 with respect to the gravitational direction, and the inclinations of the posture with respect to the roll, pitch, and yaw axes. Based on the posture detected by the posture detection unit 114, it is possible to determine whether the smartphone 100 is being held horizontally, being held vertically, facing up, facing down, being in an inclined posture, or the like. At least one of an acceleration sensor, a gyro sensor, a geomagnetic sensor, an orientation sensor, an altitude sensor, and the like, can be used as the posture detection unit 114, and multiple sensors can be used in combination.

The self-position estimation unit 115 estimates the self-position and surrounding environment of the smartphone 100 or VR goggles 200 (described later) in a space.

The “self-position” refers to the position of the smartphone 100 or the VR goggles 200 (described later) in a space. The self-position is, for example, represented by three parameters that express a position in a coordinate system defined such that a predetermined position in a predetermined range of space is set as the origin and three mutually orthogonal axes are respectively defined as X-axis, Y-axis, and Z-axis. The self-position may also be represented by additional three parameters that express a posture (orientation).

The gaze sensor unit 104 is made up of a CCD sensor or the like and photoelectrically converts an infrared image.

The image capturing unit 105 is a camera capable of acquiring pictures. The acquired pictures can be utilized for various detection processes by a gesture detection unit 102f (described later), the self-position estimation unit 115, and the like. The control unit 107 is capable of outputting information acquired by the image capturing unit to the gesture detection unit 102f, and is also capable of outputting an outside-world picture to the display 101.

The operating unit 102 includes the touch panel 102a. The control unit 107 is capable of detecting the following operations or states on the touch panel 102a.
A finger or a pen not touching the touch panel 102a newly touches the touch panel 102a, that is, the start of touch (hereinafter, referred to as touch-down)
A finger or a pen is touching the touch panel 102a (hereinafter, referred to as touch-on)
A finger or a pen is moving while touching the touch panel 102a (hereinafter, referred to as touch-move)
A finger or a pen touching the touch panel 102a has left the touch panel 102a, that is, the end of touch (hereinafter, referred to as touch-up)
Nothing is touching the touch panel 102a (hereinafter, referred to as touch-off)

When touch-down is detected, touch-on is also detected at the same time. After touch-down, touch-on is ordinarily continuously detected unless touch-up is detected. When touch-move is detected as well, touch-on is detected at the same time. Even when touch-on is detected, touch-move is not detected unless the touch position is moving. When touch-up of all the touching fingers or pen is detected, touch-off is detected.

A notification of these operations and states and the position coordinates where a finger or a pen is touching the touch panel 102a is provided to the control unit 107 via the internal bus 106. Subsequently, the control unit 107 determines what kind of operation (touch operation) has been performed on the touch panel 102a based on the provided information. Regarding touch-move, the moving direction of a finger or a pen moving on the touch panel 102a can also be determined for vertical and horizontal components on the touch panel 102a based on a change in position coordinates. When it is detected that touch-move has been performed a predetermined distance or more, it is determined that a slide operation has been performed. An operation that a finger is quickly moved only a certain distance while touching the touch panel 102a and then released is called a flick. A flick is, in other words, an operation that a finger quickly traces so as to flick on the touch panel 102a. When it is detected that touch-move has been performed a predetermined distance or more at a predetermined speed or higher and then touch-up is detected, it may be determined that a flick has been performed (it may be determined that a slide operation followed by a flick has been performed). Furthermore, touching multiple points (for example, two points) simultaneously and bringing the touch positions closer to each other is called pinch in, and moving the touch positions further apart is called pinch out. Pinch out and pinch in are collectively referred to as pinch operation (or simply pinch). Any of various types of touch panels, including resistive film type, capacitance type, surface acoustic wave type, infrared type, electromagnetic induction type, image recognition type, and optical sensor type, may be used as the touch panel 102a. There are a method that detects a touch when there is contact with a touch panel and a method that detects a touch when a finger or pen approaches a touch panel; however, any one of the methods is applicable.

The operating unit 102 includes the gesture detection unit 102f. The control unit 107 can acquire a gesture picture of the hand or the like of a user through the image capturing unit 105 and detect predetermined gestures in the gesture detection unit 102f. In other words, it is possible to acquire instructions through gestures.

The operating unit 102 includes a gaze input detection unit 102g. The control unit 107 can acquire gaze information of a user through the gaze sensor unit 104 and interpret the gaze information as a predetermined input operation in the gaze input detection unit 102g. For example, the control unit 107 detects the eye gaze of a user (the direction in which a user is looking) by using a method, such as a corneal reflex method and a scleral reflex method, based on an output signal from the gaze sensor unit 104, and interprets the detected gaze information as a predetermined input operation in the gaze input unit 102g. In other words, it is possible to acquire instructions through gaze.

### Configuration of Head Mounted Goggles

FIG. 1D is the appearance view of the VR goggles (head mounted adapter) 200 that can mount the smartphone 100. The smartphone 100 can also be used as a head mounted display by being mounted to the VR goggles 200. An insertion port 201 is an insertion port for inserting the smartphone 100. The entire smartphone 100 can be inserted into the VR goggles 200 in a state where the display surface of the display 101 is oriented toward a headband 202 (that is, a user) for fixing the VR goggles 200 to the head of the user. In this way, the user can view the display 101 of the smartphone 100 in a state where the user is wearing the VR goggles 200 on the head without holding the smartphone 100 in user's hand. In this case, when the user moves the head or the entire body, the posture of the smartphone 100 also changes. The posture detection unit 114 detects a change in the posture of the smartphone 100 at this time, and the control unit 107 executes a VR display process based on the detected change in posture. In other words, it is possible to acquire instructions for changing the view direction of VR videos from changes in posture. In this case, detecting the posture of the smartphone 100 by the posture detection unit 114 is equivalent to detecting the posture of the head of the user (the direction in which the gaze of the user is oriented). A lens 203 for the image capturing apparatus allows the image capturing unit 105 of the smartphone 100 to acquire pictures of a real space and gesture pictures of the user even while mounted to the VR goggles 200.

In the smartphone 100, the gaze, facial expression, and the like, of the user may be detected, and the information may be used as an operating method in the smartphone 100.

### Configuration of Controller

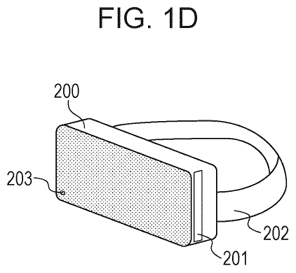

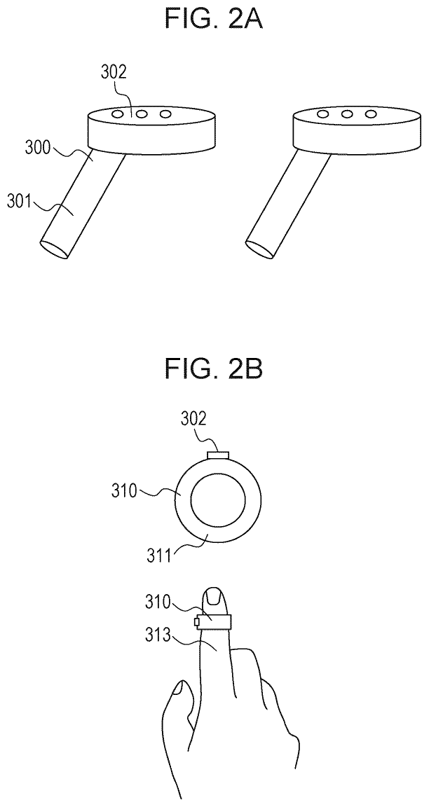

FIG. 2A is the appearance view of a controller 300 that can communicate with the smartphone 100. The grip-type controller 300 notifies the smartphone 100 of operation events when the user holds holding parts 301 with the hands and operates members on an operating surface 302.

A ring-shaped controller 310 shown in FIG. 2B includes a ring part 311 for mounting the ring-shaped controller 310 to a finger 313 of a user and a ring operating unit 312. The ring operating unit 312 may be a press button or may be a member capable of detecting contact or the like of a finger, such as a touch panel, a rotary dial, and an optical trackpad.

The controllers described above perform wireless communication with the communication I/F 113 of the smartphone 100 via Bluetooth.

### Flowchart in Present Embodiment

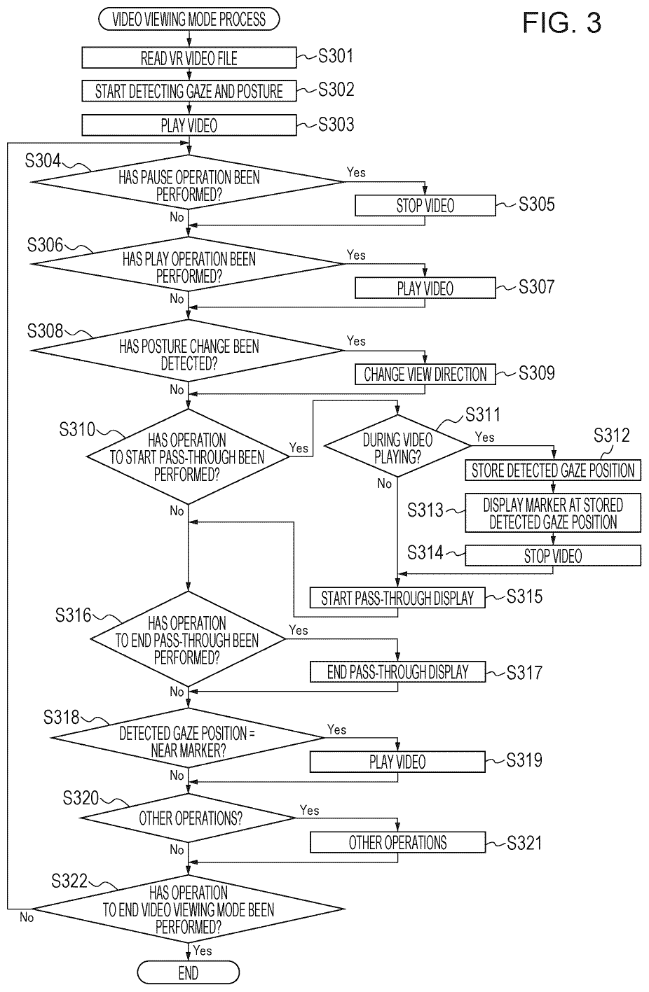

Hereinafter, a case where a user is wearing and using the VR goggles 200 with the smartphone 100 mounted will be described. A control flow of the present embodiment will be described with reference to FIG. 3. The control flow shown in FIG. 3 is processed within the control unit 107. The process of the flowchart is implemented when the control unit 107 reads a predetermined program from the memory, deploys the program to the working memory, and runs the program.

FIG. 3 is an example of a video viewing mode process in the smartphone 100.

When the smartphone 100 detects that the smartphone 100 has been mounted to the VR goggles 200, or when a user operates to play a video, the smartphone 100 executes the video viewing mode process.

In S301, the control unit 107 reads a picture file from the recording medium 116. Here, a VR video file will be described as an example.

In S302, the control unit 107 starts detecting a posture change of the smartphone 100 by the posture detection unit 114 and detecting the gaze input of the user by the gaze input detection unit 102g. In other words, the control unit 107 acquires the gaze of the user.

In S303, the control unit 107 plays the read VR video file.

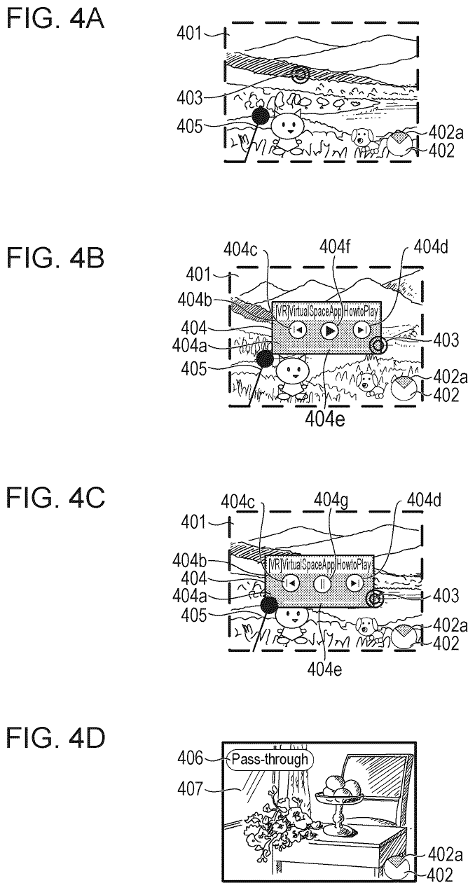

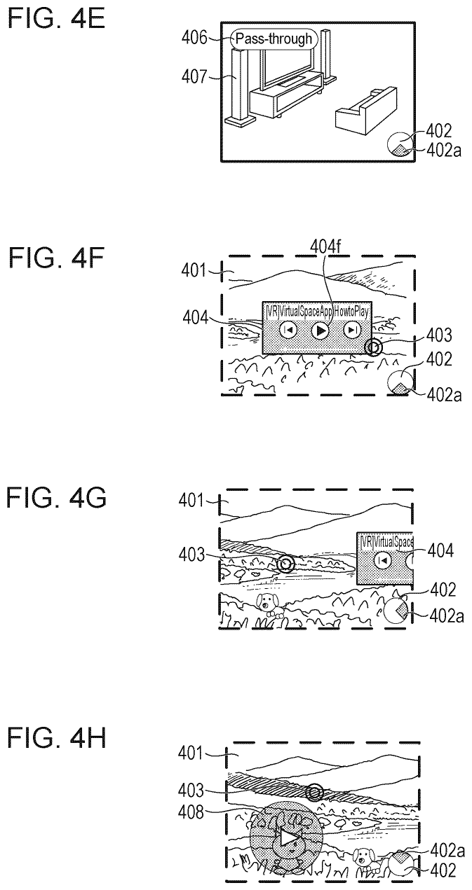

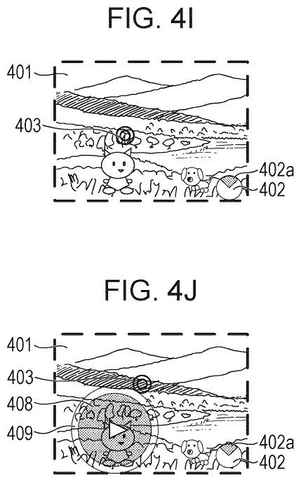

FIGS. 4A to 4J are screen examples of the smartphone 100 in video viewing mode.

FIG. 4A is a screen example in which a VR video is played. A scene that a VR video 401 is displayed and is being played is assumed. For the sake of convenience of illustration, a dashed line is drawn around a VR video, and a continuous line is drawn around a pass-through picture.

A view direction indicator 402 is displayed so as to be superimposed on the VR video 401 to show the view direction with respect to a 360° picture. The view direction indicator 402 includes a view direction 402a. A gaze pointer 403 is displayed so as to be superimposed on the VR video 401 to acquire gaze information on the user through the gaze sensor unit 104 and show a detected gaze position detected by the gaze input detection unit 102g. In other words, the control unit 107 executes gaze display control by displaying the gaze pointer 403 and causing the gaze pointer 403 to follow the gaze of the user. For example, a ray 405 indicating the direction in which the grip-type controller 300 is oriented is also displayed so as to be superimposed.

In S304, the control unit 107 determines whether an operation to pause the VR video has been performed on the operating unit 102. This is, for example, an operation on the operating surface 302 of the grip-type controller 300. When it is determined that the operation has been performed, the process proceeds to S305; whereas, when it is determined that the operation has not been performed, the process proceeds to S306.

In S305, the control unit 107 stops (pauses) the VR video.

FIG. 4B is a screen example after a pause operation has been performed. A scene that the VR video is paused as a result of an operation of the user and a GUI panel 404 for video is displayed so as to be superimposed on the VR video 401 is assumed. A background panel 404a, a VR video title 404b, switch buttons 404c, 404d for switching a video file to be played, a video timeline 404e, and a play icon 404f for playing a video are displayed so as to be superimposed on the GUI panel 404. In other words, since it is currently paused, a play icon to resume the VR video 401 is displayed. 404c to 404f denote GUI components that can accept user operation. When the gaze pointer 403 or the ray 405 is moved to nearby and combined with another selection operation, it is possible to activate the functions indicated by the GUI components located near the positions indicated by the gaze pointer 403 or the ray 405.

In S306, the control unit 107 determines whether an operation to play the VR video has been performed on the operating unit 102. In other words, in S306, the control unit 107 executes playback control. When it is determined that the operation has been performed, the process proceeds to S307; whereas, when it is determined that the operation has not been performed, the process proceeds to S308.

In S307, the control unit 107 plays (resumes) the VR video.

FIG. 4C is a screen example after the play operation has been performed. In the pause screen of FIG. 4B, a scene that there is an operation to select the play icon 404f by the user to play the video and the video is resumed is assumed. The GUI panel 404 for video is displayed so as to be superimposed on the VR video 401. A pause icon 404g for pausing a video is displayed so as to be superimposed on the GUI panel 404. When the video is played by the operation to select the play icon 404f, the play icon 404f switches to the pause icon 404g. When the video is played, the GUI panel 404 is hidden after a certain amount of time. The GUI panel 404 may be hidden by an explicit user operation on the operating unit 102.

In S308, the control unit 107 determines whether a posture change has been detected in the posture detection unit 114. When it is determined that the posture change is detected, the process proceeds to S309; whereas, when it is determined that the posture change is not detected, the process proceeds to S310.

In S309, the view direction is changed according to the detected posture change. The screen is refreshed such that the direction of the view direction 402a within the view direction indicator 402 is associated with the changed view direction.

In S310, the control unit 107 determines whether an operation to start pass-through has been performed on the operating unit 102. When it is determined that the operation has been performed, the process proceeds to S311; whereas, when it is determined that the operation has not been performed, the process proceeds to S316.

In S311, the control unit 107 determines whether the VR video is being played. When it is determined that the VR video is being played, the process proceeds to S312; whereas, when it is determined that the VR video is not being played, the process proceeds to S315.

In S312, the control unit 107 stores the gaze position, detected by the gaze input detection unit 102g, in the working memory 108. In the present embodiment, the gaze position is used; however, the gaze coordinates or the gaze region may also be used, and it is sufficient to store information related to the gaze information in the working memory 108. The control unit 107 may calculate information to be stored as needed after acquiring the gaze.

In S313, the control unit 107 displays a marker (described later) in the VR video at the stored gaze position. This marker indicates the position at which the user was looking before the start of the pass-through, and indicates the position where the play icon is displayed when the user ends the pass-through function and resumes the video.

In S314, the control unit 107 stops (pauses) the VR video. The process of S314 may be performed before S312.

In S315, the control unit 107 ends VR video display and starts pass-through display. In other words, the video is stopped. FIG. 4D is a screen example after switching to pass-through display. A scene in which display is switched from the scene of FIG. 4C to pass-through display and, as illustrated by the view direction indicator 402, the view direction remains unchanged and the mode is switched to the pass-through function is assumed. A pass-through icon 406 indicating that it is in pass-through mode is displayed so as to be superimposed on a pass-through picture 407. The view direction indicator 402 is also displayed so as to be superimposed. Here, the VR video in FIG. 4C and the pass-through picture in FIG. 4D take over the view direction 402a.

FIG. 4E is a screen example of a state of viewing straight behind (180° opposite direction) from the state of FIG. 4D. A scene that the user looks straight behind using the pass-through function is assumed. One example of a scene where such a pass-through function is used is confirming safety or the like. For example, when colliding with an obstacle, there is presumably a case where a video is stopped. The content displayed in the pass-through picture 407 changes, and the view direction 402a is also reversed by 180°.

In S316, the control unit 107 determines whether an operation to end pass-through has been performed on the operating unit 102. When it is determined that the operation has been performed, the process proceeds to S317; whereas, when it is determined that the operation has not been performed, the process proceeds to S318.

In S317, the control unit 107 ends pass-through display and starts VR video display. When VR video display is started, the process proceeds to S318. When VR video display is started, the process of S313 may be inserted before proceeding to S318. In this case, the process of S313 is skipped after S312, and the process proceeds to S314.

FIG. 4F is a screen example after ending the pass-through. A scene in which display is switched from the scene of FIG. 4E to a video viewing screen and, as illustrated by the view direction indicator 402, the view direction remains unchanged and the mode is switched from the scene of FIG. 4E to the video viewing screen is assumed. Compared to the scene of FIG. 4C, the view direction is a 180° opposite direction, and the view direction appears to be oriented in the opposite direction according to the view direction indicator 402 as well. In other words, the view direction of the VR video is changed in response to an operation to change the view direction by the user. The GUI panel 404 for video is displayed so as to be superimposed on the VR video 401. In this state, the video remains paused, and the play icon 404f for playing the video is displayed so as to be superimposed on the GUI panel 404.

FIG. 4G is a screen example in which the view direction has been rotated by 90° to the left from the scene of FIG. 4E. A scene in which the user is moving the screen at the time of trying to resume the video from the view direction set before the pass-through function is used is assumed. It is assumed that the GUI panel 404 is displayed fixedly in the displayed view direction. Therefore, when the view direction is changed as shown in FIG. 4G, the display position changes so as to follow the VR video 401 in the background.

FIG. 4H shows a state where the view direction has been further changed from FIG. 4G and is oriented in the same direction as FIGS. 4A to 4C. A scene in which the user is facing the same direction as the previous view direction at the time of trying to resume the video from the view direction set before the pass-through function is used is assumed. A scene in which the current view point of the user is displayed with the gaze pointer 403 and is about to reach the marker 408 used as the play icon when resuming the video is assumed. In other words, a scene in which the user is trying to resume the VR video 401 based on the positional relationship between the gaze pointer 403 and the marker 408 is assumed. Here, prior to pass-through display, the marker 408 indicating the stored gaze position displayed in S313 is displayed so as to be superimposed.

In S318, the control unit 107 determines in the gaze detection unit 102c whether the detected gaze position, that is, the gaze pointer 403, is near the marker 408. When it is determined that the gaze pointer 403 is near the marker 408, the process proceeds to S319; whereas, when it is determined that the gaze pointer 403 is not near the marker 408, the process proceeds to S320.

In S319, the control unit 107 plays (resumes) the VR video. In other words, in S319, the control unit 107 executes playback control. FIG. 4I shows a state where the video is resumed. When the user faces the same direction as the past view direction, the marker 408 is displayed at the position at which the user was looking before the start of pass-through and is used as a play icon at the time of resuming the video. A scene in which the gaze pointer 403 that is the view point of the user reaches the marker 408 and the VR video 401 is resumed is assumed. The marker 408 is hidden when the video resumes.

In S320, the control unit 107 determines whether any other operations have been performed on the operating unit 102. Examples of the other operations include an operation to read another video file recorded on the recording medium 116 by operating the switch buttons 404c, 404d, and an operation to change the playback position on the video timeline by operating the timeline 404e. When it is determined that the operation has been performed, the process proceeds to S321; whereas, when it is determined that the operation has not been performed, the process proceeds to S322.

In S321, the control unit 107 executes the other processes based on the operation in S320.

In S322, the control unit 107 determines whether an operation to end the video viewing mode has been performed on the operating unit 102. When it is determined that the operation has been performed, the process ends; whereas, when it is determined that the operation has not been performed, the process returns to S304.

In each of the above-described assumed scenes, the detected gaze position and the gaze pointer are matched; however, the range of the detected gaze position detected by the gaze sensor unit 104 and the size of the gaze pointer 403 displayed based on the detected range may be switched as needed. For example, one coordinate that is the minimum unit detectable by the gaze sensor unit 104 may be adopted as the detected gaze position, or multiple coordinates may be adopted. Planes or regions calculated from multiple coordinates may be stored as the detected gaze position. The size of the gaze pointer 403 may match the range of the detected gaze position, or may be different from the range of the detected gaze position. For example, when one coordinate that is the smallest detectable unit is adopted as the detected gaze position, accuracy increases when the gaze pointer 403 is displayed so as to fit to the range. However, since the gaze pointer 403 is small and there is a risk of reduction in visibility, the gaze pointer 403 may be displayed so as to be larger than the minimum unit of the gaze pointer range.

The range of detected gaze position stored in S312 and the size of the region for determining whether to resume the video in S318 based on that range, that is, the size of the marker 408 used as the play icon at the time of resuming the video, may be switched as needed. For example, the detected gaze position stored in S312 may be such that one coordinate that is the minimum unit detectable by the gaze sensor unit 104 is stored or may be such that multiple coordinates are stored. Planes calculated from multiple coordinates may be stored as the detected gaze position. The size of the region for determining whether to resume the video in S318 may match the range of the detected gaze position stored in S312, or may be different from the range of the detected gaze position. For example, when one coordinate that is the minimum unit in which the detected gaze position stored in S312 can be detected is adopted, accuracy increases when the size of the region for determining whether to resume the video is set so as to fit that range. However, since it may be difficult to orient the gaze, the marker 408 used as the play icon at the time of resuming the video may be set so as to be larger than the range of the detected gaze position or the gaze pointer 403.

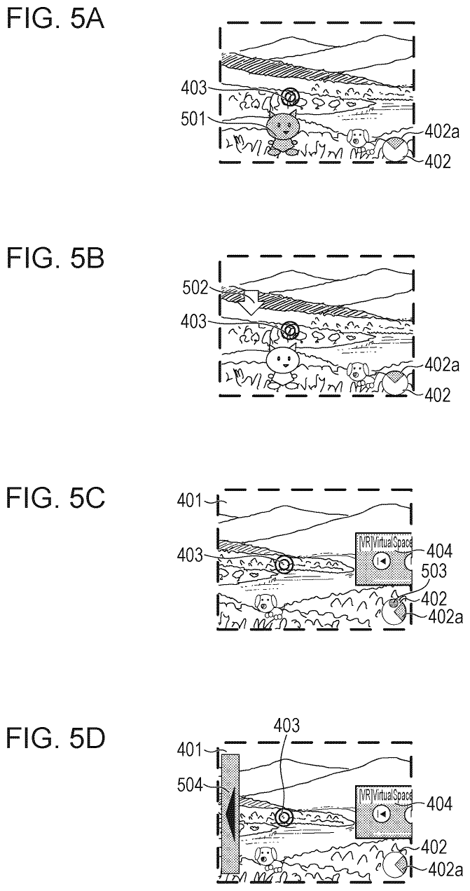

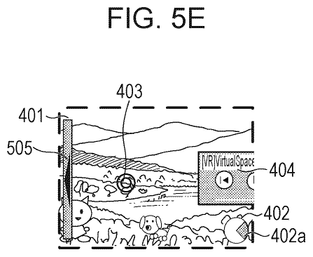

The size and shape of the marker 408 may also be similarly changed as needed. For example, when only one coordinate that is minimum unit detectable by the gaze sensor unit 104 is stored in S312, the marker may indicate the strict one point. When the detected gaze position is stored as a plane in S312, the size of the marker 408 may also be changed according to the area. The marker 408 may be displayed in a range wider than the point (plane) stored in S312, and the video may be played when the gaze pointer 403 is displayed near the marker or within the range. A predetermined object 501 may be stored as shown in FIG. 5A, or an arrow 502 indicating the stored position of coordinate or region may be displayed as shown in FIG. 5B. The stored position of coordinate or region does not need to be displayed so as to be superimposed on the VR video.

Regarding the positional relationship between the gaze pointer 403 and the marker 408, the VR video 401 may be resumed when the gaze pointer 43 and the marker 408 come into contact with each other, or the VR video 401 may be resumed when the gaze pointer 403 and the marker 408 overlap in a predetermined part.

It may be determined to resume the video based on the fact that the gaze pointer 403 has been continuously displayed near the marker 408 (the marker 408 has been gazed) for a predetermined time. In other words, it may be determined to resume the video based on the fact that a predetermined time has elapsed in a state where the gaze pointer 403 is near the marker 408. It may be determined to resume the video based on the fact that a predetermined time has elapsed in a state where the gaze pointer 403 is not near the marker 408 but is in contact with the marker 408, completely matches the marker 408, partially matches the marker 408, or falls within the region of the marker 408.

If the gaze pointer 403 moves to the outside of the range of the marker 408 due to fixational eye movements or the like before the count of the predetermined time for gaze determination expires, a buffer region may be provided. FIG. 4J is an example in which a buffer region is provided. Similar to FIG. 4H, when the user is trying to resume the video from the view direction before using the pass-through function, the user faces the same direction as the previous view direction, and the view point of the user is represented by the gaze pointer 403. A scene in which a buffer region 409 is set around the marker 408 and the gaze pointer 403 soon reaches the buffer region 409 is assumed. Such a buffer region may be displayed in a form that can be visually recognized by the user or does not need to be displayed because many components are displayed and complicated. One example of a method of using a buffer region is as follows. The count for the gaze determination starts from the time point when the gaze pointer 403 enters the marker 408. Even when the gaze pointer 403 goes outside the range of the marker 408 during the period from the start of the count to the expiration of the count, the count for gaze determination is continued when the gaze pointer 403 is within the buffer region 409.

The processes of S312 and S318 do not need to perform the above-described operation when the housing including the smartphone 100 is in a significantly unstable state. Examples of the state where the housing including the smartphone 100 significantly lacks stability include a state where the user is currently wearing the VR goggles.

The detected gaze position stored in S312 may be multiple positions, and accordingly, multiple markers 408 may be displayed.

In S312, the detected gaze position is stored; however, information on the posture, self-position, or the like, of the smartphone 100 may be stored. Then, when information on the posture, self-position, or the like, of the smartphone 100 matches the stored information on the posture, self-position, or the like, of the smartphone 100 at the time when it is determined whether to resume the video in S318, the video may be resumed. In other words, the video may be resumed when the current display range of the VR video 401 matches the stored past display range by a predetermined range or more. The detected gaze position may also be stored and may be used in combination to determine whether to resume the video.

When an operation to start pass-through has been performed while the VR video 401 is being played in S311, the detected gaze position is stored in S312. Instead, the process of S312 may be executed even in a state where the VR video 401 is in a paused state by operating the pause icon 404g to pause the video.

In FIG. 4F, there are cases where the user cannot remember the past detected gaze position because the position of the display range has been changed. For such cases, a direction notification that informs the direction toward the detected gaze position may be provided. In other words, the control unit 107 may execute notification control.

As a method of such a direction notification, a mark 503 may be displayed on the view direction indicator 402 as shown in FIG. 5C, or an indicator 504 indicating a direction may be added on the screen as shown in FIG. 5D. In other words, a notification may be provided within the display portion like the display. As shown in FIG. 5E, an indicator may be changed so as to indicate a relative position as in the case of an indicator 505 that indicates a direction.

The smartphone 100 may be used without being mounted to the VR goggles 200. In this case, a user holds the smartphone 100 in user's hand to view a VR video. In this case, unlike when the smartphone 100 is mounted to the VR goggles 200, the user can see objects other than the display of the smartphone 100. In this case, the above-described direction notification may be provided by using sound, vibration, light, or the like. In other words, a notification may be provided other than the display portion like the display. For example, when a notification is provided through sound, specific instructions may be provided from the audio output unit 103, or a notification sound may be provided from the audio output unit 103.

The present disclosure may be implemented not before and after the pass-through function but before and after using functions other than VR videos.

As methods of resuming to view a VR video at a selected angle of view, besides the above-described methods, the GUI panel 404 may be designed to be displayed when a touch-down operation is detected on the touch panel 102a.

### Second Embodiment

### Normal Angle of View

Not limited to VR videos, pictures with a normal angle of view may be employed. When a picture has a normal angle of view but the screen is large and all the image on the screen cannot be visually recognized once, missing out may occur. In such cases, it is possible to reduce missing out by applying the present disclosure.

In an example, the present disclosure may be implemented in a digital camera equipped with an electronic viewfinder. In the playback mode of the digital camera, when an operation to switch to an image capture mode is performed on the operating unit 102 while a video recorded on the recording medium 116 is displayed on the display 101 and being played, the video is paused, and a live view is displayed on the display 101. This corresponds to the pass-through display that has been described so far. At the same time, a detected gaze position that has been being viewed during video playing may be held, and the video may be automatically resumed by gazing the stored detected gaze position of the paused video at the time of transitioning to the playback mode subsequently.

### OTHER EMBODIMENTS

The present disclosure is implemented by executing the following process. That is, the process is a process in which software (program) that implements the functions of the above-described embodiments is supplied to a system or device via a network or various storage media and a computer (or a control unit, an MPU, or the like) of the system or apparatus reads and executes a program code. In this case, the program and the storage medium storing the program constitute the present disclosure.

The above-described various controls described as being executed by the control unit may be executed by a single piece of hardware, or the control of the overall apparatus may be executed by multiple pieces of hardware sharing the process.

The present disclosure has been described in detail in accordance with its preferred embodiments; however, the present disclosure is not limited to those specific embodiments, and various modes that do not depart from the purport of the disclosure are also included in the present disclosure. Furthermore, each of the above-described embodiments merely illustrates an embodiment of the present disclosure, and it is also possible to combine the embodiments as needed.

The present disclosure can be implemented by a process of supplying a program for implementing one or more functions of the above-described embodiments to a system or apparatus via a network or storage medium, and causing one or more processors in the computer of the system or apparatus to read and run the program. Alternatively, the present disclosure may be implemented by a circuit (for example, ASIC) that implements one or more functions.

The present disclosure is not limited to the above-described embodiments. Various changes and modifications are applicable without departing from the spirit and scope of the present disclosure. Therefore, the following claims are attached to show the scope of the present disclosure.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus comprising:
a display control unit configured to display a video on a display;
a gaze acquisition unit configured to acquire gaze information indicating a position or range at which a user is looking within a display range of the video displayed on the display;
a recording unit configured to record the gaze information acquired by the gaze acquisition unit; and
a playback control unit configured to execute control to stop the video when display of the video is stopped while the video is being played, and, when display of the video is resumed, execute control to resume the video based on gaze information indicating a position or range at which the user is currently looking and the gaze information recorded by the recording unit before display of the video is resumed.

2. The information processing apparatus according to claim 1, further comprising
an instruction acquisition unit configured to acquire an instruction for changing a position of a display range of the video in response to operation by the user, wherein
the display control unit is configured to execute control to display a part of the video on the display as the display range, and change the position of the display range of the video according to the instruction.

3. The information processing apparatus according to claim 2, wherein
the instruction acquisition unit is configured to acquire a detection result of a position or posture of the display as the instruction, and
the display control unit is configured to change the position of the display range according to a change of the position or posture of the display

4. The information processing apparatus according to claim 2, wherein
the instruction acquisition unit is configured to acquire a detection result of at least one of touch operation on the display, operation by gaze, and operation by gesture as the instruction.

5. The information processing apparatus according to claim 3, wherein
the display control unit is configured to, when the position or posture of the display has changed compared to when display of the video is stopped, change the position of the display range of the video in a case where display of the video is resumed, from the position of the display range of the video when display of the video is stopped, according to the change of the position or posture of the display.

6. The information processing apparatus according to claim 1, wherein
the display control unit is configured to display an item indicating the position or the range based on the gaze information recorded by the recording unit before display of the video is resumed, such that the item is superimposed on the video.

7. The information processing apparatus according to claim 6, further comprising
a gaze display control unit configured to execute control such that a pointer that follows current gaze of the user is displayed so as to be superimposed on the video, wherein
the playback control unit is configured to resume the video based on a positional relationship between the item and the pointer.

8. The information processing apparatus according to claim 7, wherein
the playback control unit is configured to, when the pointer and the information indicating the position or the range overlap in a predetermined part, execute control to play the video.

9. The information processing apparatus according to claim 7, wherein
the playback control unit is configured to, when a predetermined time has elapsed in a state where the pointer and the information indicating the position or the range overlap in a predetermined part, execute control to play the video.

10. The information processing apparatus according to claim 1, further comprising
a notification control unit configured to, when display of the video is resumed, execute control to provide a notification of a direction from a position of a current display range toward a position of a display range corresponding to the gaze information based on the gaze information and the position of the current display range.

11. The information processing apparatus according to claim 10, wherein
the notification control unit is configured to execute control to provide a notification of a relative position of the gaze information with respect to the current display range.

12. The information processing apparatus according to claim 10, wherein
the notification control unit is configured to execute control to provide a notification by at least one of sound, vibration, and light other than the display.

13. The information processing apparatus according to claim 10, wherein
the notification control unit is configured to execute control to provide a notification such that the notification is displayed so as to be superimposed on the video within the display.

14. The information processing apparatus according to claim 1, wherein
the recording unit is configured to further record a display range of a video displayed on the display, and
the playback control unit is configured to, in a state where the display range of the video recorded by the recording unit before display of the video is resumed, matches a predetermined range of a current display range of the video, execute control to resume the video based on gaze information indicating a position or range at which the user is currently looking and the gaze information recorded by the recording unit before display of the video is resumed.

15. The information processing apparatus according to claim 1, wherein
the playback control unit is configured to, when display of the video is resumed, execute control to resume the video based on gaze information indicating a position or range at which the user is currently looking and the gaze information when the video is stopped, the gaze information being recorded by the recording unit.

16. The information processing apparatus according to claim 1, wherein
the playback control unit is configured to, when display of the video is resumed, execute control to resume the video based on gaze information indicating a position or range at which the user is currently looking and the gaze information when an operation to stop display of the video has been performed, the gaze information being recorded by the recording unit.

17. A control method for an information processing apparatus, the control method comprising:
a display control step of displaying a video on a display;
a gaze acquisition step of acquiring gaze information indicating a position or range at which a user is looking within a display range of the video displayed on the display;
a recording step of recording the gaze information acquired by the gaze acquisition step; and
a playback control step of executing control to stop the video when display of the video is stopped while the video is being played, and, when display of the video is resumed, executing control to resume the video based on gaze information indicating a position or range at which the user is currently looking and the gaze information recorded by the recording step before display of the video is resumed.

18. A system for an information processing apparatus, the system comprising:
a display control device configured to display a video on a display;
a gaze acquisition device configured to acquire gaze information indicating a position or range at which a user is looking within a display range of the video displayed on the display;
a recording device configured to record the gaze information acquired by the gaze acquisition device; and
a playback control device configured to execute control to stop the video when display of the video is stopped while the video is being played, and, when display of the video is resumed, execute control to resume the video based on gaze information indicating a position or range at which the user is currently looking and the gaze information recorded by the recording device before display of the video is resumed.
